(19) United States
(12) Patent Application Publication
(10) Pub. No.: US 2007/0172788 A1
(43) Pub. Date: Jul. 26, 2007

(54) HYBRID ORTHODONTIC ARCHWIRE

(76) Inventors: Charles F. Hill II, Highlands Ranch, CO (US); Philip P. Soo, Fullerton, CA (US); Ming-Lai Lai, Arcadia, CA (US); John J. Palmer, Monrovia, CA (US)

Correspondence Address: 3M INNOVATIVE PROPERTIES COMPANY, PO BOX 33427, ST. PAUL, MN, 55133-3427, US

(21) Appl. No.: 11/275,650

(22) Filed: Jan. 20, 2006

(51) Int. Cl. A61C 3/00

(52) U.S. Cl. 433/20

(57) ABSTRACT

An archwire used during the course of orthodontic treatment has four generally flat sides that are arranged in the general shape of a rectangle. The four sides are connected by curved surfaces having a radius of curvature that is substantially larger than the corners of conventional archwires. The cross-sectional shape of the archwire facilitates insertion and removal of the archwire in orthodontic appliances such as brackets and also tends to reduce resistance to sliding movement of the appliances along the archwire.

### BACKGROUND OF THE INVENTION

1. Field of the Invention

This invention broadly relates to archwires that are used during the use of orthodontic treatment. More particularly, the present invention concerns an orthodontic archwire having a configuration that facilitates treatment as well as its insertion and removal by the orthodontist.

2. Description of the Related Art

Orthodontia is a specialty within the general field of dentistry, and involves movement of malpositioned teeth to orthodontically correct positions. Orthodontic treatment can greatly enhance the patient's facial appearance, especially in areas near the front of the patient's mouth. Orthodontic treatment can also help improve the patient's occlusion so that the teeth function better with each other during mastication.

One type of orthodontic treatment involves the use of tiny slotted devices known as brackets that are fixed to the patient's teeth. A resilient archwire is inserted into the slot of each bracket and serves as a track to guide movement of the brackets along with the associated teeth to desired positions. Ends of the archwire are often placed in tiny devices known as buccal tubes that are fixed to the patient's molar teeth.

Many commonly available orthodontic brackets have an archwire slot with a rectangular cross-sectional configuration. The rectangular shape of the archwire slot is adapted to mate with archwires having rectangular configurations in longitudinally transverse cross-sectional reference planes. The matching, rectangular shapes of the slot and the archwire serve to non-rotatably couple each bracket to the archwire. As a consequence, the orthodontist can, if desired, twist or bend the archwire between adjacent teeth in order to impose a torquing or uprighting force on the teeth as may be needed to correct the position of a particular tooth or teeth.

Archwires having round cross-sectional configurations are also known and are sometimes used during initial stages of orthodontic treatment. Round archwires typically have a relatively low stiffness and are often used when the teeth are initially severely maloccluded, since these archwires offer little resistance to bending and can be ligated to each bracket without significant force. For example, when a pair of adjacent teeth are significantly offset with respect to each other in directions along a reference axis extending from the lips or cheeks to the patient's tongue, low stiffness round archwires are often deemed satisfactory for moving such teeth closer together without causing undue pain to the patient. Round archwires also are less likely to bind and are believed to allow freer movement of the brackets along the archwire. Unfortunately, round archwires can rotate in the rectangular slots of brackets and as a result do not allow the orthodontist to apply a torquing or uprighting force as may be desired on selected teeth by placing bends or twists in the archwires.

In the past, orthodontists often used a ligature such as a wire tie or elastomeric O-ring to retain the archwire in the archwire slot of a bracket. To this end, the brackets were often provided with small wings known as tiewings that extended outwardly from the body of the bracket. The ligature is placed behind the tiewings and across the front of the archwire in order to urge the archwire toward a seated position in the archwire slot.

Recently, there has been increased interest in orthodontic brackets that have a latch for retaining the archwire in the archwire slot. Brackets of this type are widely known as self-ligating appliances and often obviate the need to use ligatures in the manner described above. Examples of self-ligating brackets include brackets with sliding doors or shutters. Improved self-ligating orthodontic appliances having a self-releasing latch are described in applicant's U.S. Pat. Nos. 6,302,688 and 6,582,226.

One type of self-ligating appliance, commercially known as “SMARTCLIP” brand appliance from 3M Unitek Corporation, has a latch that comprises two resilient clips, and each clip has a generally “C”-shaped configuration. Each clip spreads open to admit an archwire into an archwire slot of the appliance when the archwire is pressed against an opening of the clip. In addition, the clips spread open to release the archwire from the archwire slot whenever the force presented by the archwire against the clip in locations adjacent the opening is greater than a certain amount.

Many practitioners believe that self-ligating brackets tend to move more freely along the archwire than might be observed if, by comparison, the combination of a ligature and bracket is used. As such, there is a belief that the use of self-ligating brackets may reduce the overall amount of time needed for treatment, resulting in a savings of time and money for the practitioner as well as the patient. Moreover, some practitioners prefer to use self-ligating appliances because the need to secure the archwire to the appliances by connecting a ligature to each appliance can be avoided.

### SUMMARY OF THE INVENTION

The present invention is directed toward orthodontic archwires having an improved cross-sectional configuration. The archwires include four flat sides as well as four curved surfaces that interconnect the four flat sides. The curved surfaces facilitate insertion of the archwire in certain appliances such as the self-ligating brackets mentioned above with clips as well as insertion in buccal tube appliances and brackets that are not self-ligating brackets. In addition, the distance between two of the four flat sides is increased in comparison to conventional archwires that provide equivalent torque control in order to maintain good torque control over the associated appliance and the adjacent tooth.

In more detail, the present invention in one aspect relates to an orthodontic archwire having a central longitudinal axis and four generally flat sides including a lingual side. The four sides present a generally rectangular configuration in a reference plane perpendicular to the longitudinal axis. The archwire also has four curved surfaces interconnecting the four sides. Each of the curved surfaces adjacent the lingual side has a radius of curvature when considered in the reference plane that is in the range of about 30% to about 45% of the overall distance between two of the sides in directions along an occlusal-gingival reference axis.

Another aspect of the present invention is also directed toward an orthodontic archwire having a central longitudinal axis and four generally flat sides. The four sides present a generally rectangular configuration in a reference plane perpendicular to the longitudinal axis. The archwire also has four curved surfaces interconnecting the four sides. The radius of curvature of each curved surface in the reference plane is in the range of about 0.006 inch (0.15 mm) to about 0.009 inch (0.23 mm).

The present invention is also directed in another aspect toward an orthodontic brace. The brace comprises at least one bracket having an elongated archwire slot and an elongated archwire received in the archwire slot. The archwire includes four generally flat sides including a lingual side that together present a generally rectangular configuration in reference planes perpendicular to the longitudinal axis of the archwire. The archwire also includes four curved surfaces interconnecting the four sides. The archwire slot and the archwire each have a certain average overall dimension in directions along an occlusal-gingival reference axis, and the average overall dimension of the archwire along the reference axis is in the range of about 76% to about 94% of the average overall dimension of the archwire slot along the reference axis. In addition, each of the curved surfaces adjacent the lingual side has a radius of curvature in the reference planes that is in the range of about 30% to about 45% of the overall dimension of the archwire along the reference axis.

The hybrid orthodontic archwires of the present invention provide the advantages of both rectangular and round archwires, i.e. archwires having rectangular cross-sectional configurations and archwires having round cross-sectional configurations. In particular, the orthodontic archwires of the present invention provide less resistance to movement of the appliances along the archwires during treatment. This tends to reduce the overall treatment time needed to move the teeth to desired positions, resulting in a savings of time and money.

The curved surfaces of the hybrid archwires facilitate alignment, insertion and removal of the archwires into the archwire slot of appliances including self-ligating appliances having clips. The increased radius of curvature of the curved surfaces, in combination with the reduced width of the flat side along the lingual side of the archwire, provides more leeway during insertion of the archwire into the archwire slot and reduces the likelihood that the portions of the bracket adjacent the archwire slot will contact and interfere with insertion. Moreover, the curved surfaces facilitate insertion of the ends of the archwires in appliances having closed passages such as buccal tube appliances. Yet, the flat sides of the archwire are spaced apart at a distance that provides good control over torque movement between the archwire and the associated appliance.

These and other features of the invention are set out in the paragraphs that follow and are illustrated in the accompanying drawings.

### BRIEF DESCRIPTION OF THE DRAWINGS

FIG. 1 is a frontal view of exemplary dental arches of a patient undergoing orthodontic treatment, wherein upper and lower dental arches each have an orthodontic brace with an orthodontic archwire according to one embodiment of the present invention;

FIG. 2 is a plan view looking down toward one of the dental arches and brace shown in FIG. 1;

FIG. 3 is a cross-sectional view of the orthodontic archwire illustrated in FIGS. 1 and 2, taken along lines 3-3 of FIG. 2;

FIG. 3a is a view somewhat similar to FIG. 3 but illustrating a cross-sectional view of an orthodontic archwire according to an alternative embodiment of the invention;

FIG. 4 is a view somewhat similar to FIG. 3 except showing a cross-sectional view of a prior art orthodontic archwire;

FIG. 5 is a perspective view of one of the orthodontic brackets of the brace shown in FIG. 2, illustrating an exemplary bracket for use with the orthodontic archwires of the present invention;

FIG. 6 is a fragmentary schematic view illustrating engagement of an orthodontic archwire of the present invention with a latch of the bracket depicted in FIG. 5;

FIG. 7 is a graph illustrating the results of experimental data relating to the force observed when engaging archwires with orthodontic brackets such as the bracket shown in FIG. 5, comparing the forces observed when using archwires according to the present invention and when using conventional known in the art;

FIG. 8 is a graph somewhat similar to FIG. 7 but showing the results of experimental data relating to the force observed when disengaging archwires from orthodontic brackets; and

FIG. 9 is a graphical representation of data relating to resistance to sliding movement of orthodontic brackets along archwires for various angular inclinations of the archwire relative to the archwire slots of the brackets.

### DEFINITIONS

“Mesial” means in a direction toward the center of the patient's curved dental arch.
“Distal” means in a direction away from the center of the patient's curved dental arch.
“Occlusal” means in a direction toward the outer tips of the patient's teeth.
“Gingival” means in a direction toward the patient's gums or gingiva.
“Facial” means in a direction toward the patient's cheeks or lips.
“Lingual” means in a direction toward the patient's tongue.

### DETAILED DESCRIPTION OF THE PREFERRED EMBODIMENTS

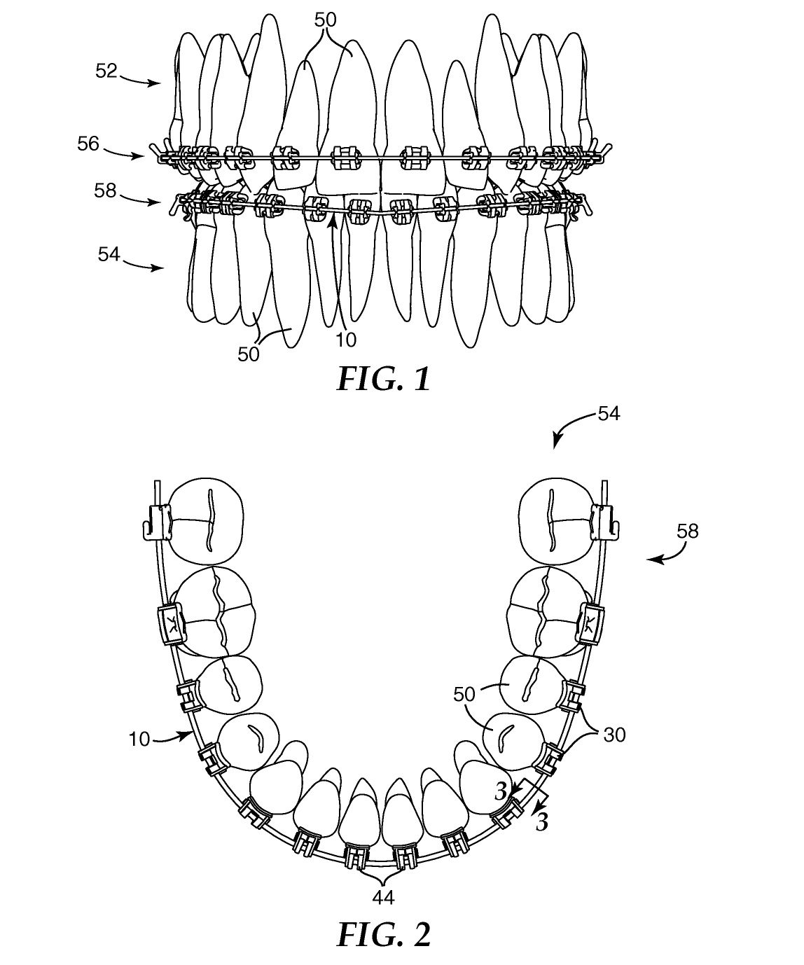

FIG. 1 illustrates an exemplary set of teeth 50 of a patient that is in orthodontic treatment. The teeth 50 include a number of teeth of an upper dental arch 52 and a number of teeth of a lower dental arch 54. An upper orthodontic brace 56 is received on the upper dental arch 52 and a lower orthodontic brace 58 is received on the lower dental arch 54. A top view of the lower dental arch 54 and lower brace 58 is shown in FIG. 2.

The lower brace 58 includes an orthodontic archwire that is broadly designated by the numeral 10 in FIGS. 1 and 2. Although the archwire 10 is shown as part of the lower brace 58, it should be understood that the archwire 10 may be used for the upper brace 56 as well.

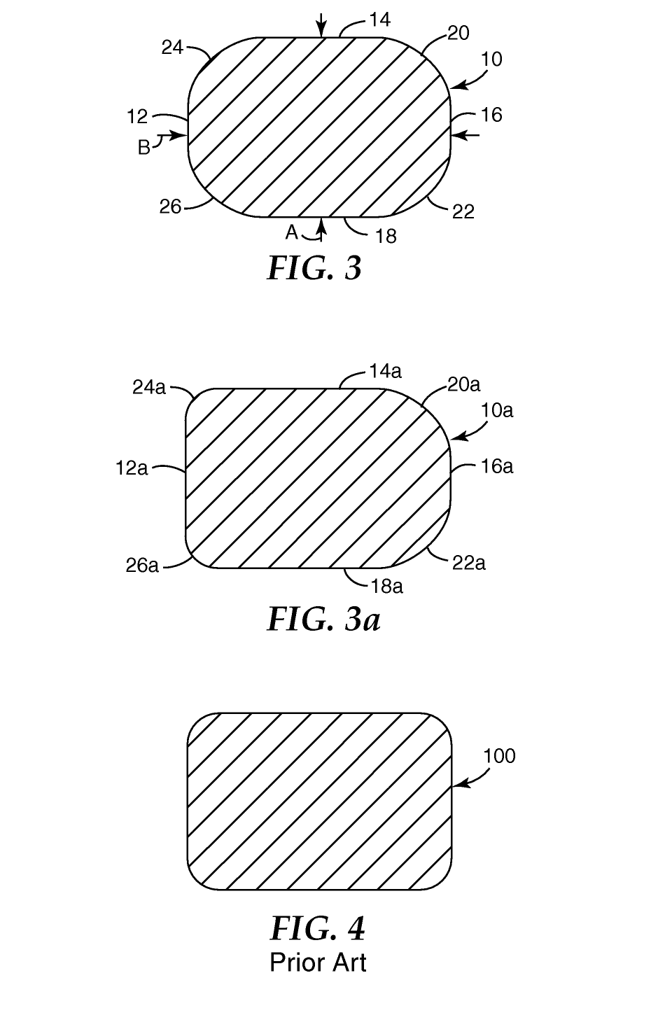

A cross-sectional view of the archwire 10 is illustrated in FIG. 3. In this embodiment, the cross-sectional shape shown in FIG. 2 is typical of the cross-sectional shape of the archwire 10 along its entire length. Preferably, the cross-sectional shape of the archwire 10 is substantially uniform along its entire length. However, other embodiments are possible, such as archwires wherein the cross-sectional shape of the archwire varies from one portion to the next along the length of the archwire.

The archwire 10 has a central longitudinal axis and four sides that preferably extend along the entire extent of the archwire 10. In particular, the archwire 10 includes a facial side 12, an occlusal side 14, a lingual side 16 and a gingival side 18 as depicted in FIG. 3.

The archwire 10 also includes four curved surfaces that interconnect the four sides 12-18. Specifically, the archwire 10 includes a first curved surface 20 that interconnects the occlusal side 14 and the lingual side 16, and a second curved surface 22 that interconnects the lingual side 16 and the gingival side 18. The archwire 10 also includes a third curved surface 24 that interconnects the occlusal side 14 and the facial side 12, and a fourth curved surface 26 that interconnects the facial side 12 and the gingival side 18.

The four sides 12, 14, 16, 18 of the exemplary cross-sectional shape of the archwire 10 as shown in FIG. 3 present a rectangle. The occlusal side 14 and the gingival side 18 are generally flat and parallel to each other, and the facial side 12 and the lingual side 16 are flat and parallel to each other. The distance between the sides 14, 18 is selected to matingly fit within an archwire slot or passage of an orthodontic appliance such as a bracket or buccal tube.

The radius of curvature of the first and second curved surfaces 20, 22 is preferably greater than about 30%, more preferably greater than about 35% and most preferably greater than about 38% of the average overall distance between the occlusal side 14 and the gingival side 18. The radius of curvature of the first and second curved surfaces 20, 22 is preferably in the range of about 30% to about 45%, more preferably in the range of about 35% to about 42% and most preferably in the range of about 38% to about 41% of the average overall distance between the occlusal side 14 and the gingival side 18.

The radius of curvature of the third and fourth curved surfaces 24, 26 is also preferably greater than about 30%, more preferably greater than about 35% and most preferably greater than about 38% of the average overall distance between the occlusal side 14 and the gingival side 18. The radius of curvature of the first and second curved surfaces 20, 22 is preferably in the range of about 30% to about 45%, more preferably in the range of about 35% to about 42% and most preferably in the range of about 38% to about 41%, of the average overall distance between the occlusal side 14 and the gingival side 18. The radius of curvature of the surfaces 20, 22, 24, 26 is determined in a reference plane perpendicular to the longitudinal axis of the archwire 10.

In FIG. 3, the distance between the occlusal side 14 and the gingival side 18 is represented by the letter “A” while the distance between the facial side 12 and the lingual side 16 is represented by the letter “B”. Table I sets out exemplary “A” and “B” dimensions along with exemplary corner radius for archwires of selected sizes and materials. In the examples set out in Table I, the radius of curvature for each of the four corners is approximately the same and all dimensions are in inches.

TABLE I

| Designation | Material | A | B | Radius |
|---|---|---|---|---|
| 17 × 25 | Stainless Steel | 0.017 | 0.025 | 0.007 |
| 17 × 25 | Nitinol SE | 0.017 | 0.025 | 0.007 |
| 18 × 25 | Stainless Steel | 0.018 | 0.025 | 0.007 |
| 18 × 25 | Nitinol SE | 0.018 | 0.025 | 0.007 |
| 21 × 25 | Stainless Steel | 0.021 | 0.025 | 0.008 |
| 21 × 25 | Nitinol SE | 0.021 | 0.025 | 0.008 |

The radius of curvature of the surfaces 20, 22 preferably is at least 0.006 inch (0.15 mm). The radius of curvature of the surfaces 20, 22 preferably is within the range of about 0.006 inch (0.15 mm) to about 0.009 inch (0.23 mm), and more preferably is within the range of about 0.0065 inch (0.165 mm) to about 0.0085 inch (0.22 mm). Similarly, the radius of curvature of the surfaces 24, 26 preferably is at least 0.006 inch (0.15 mm). The radius of curvature of the surfaces 24, 26 preferably is within the range of about 0.006 inch (0.15 mm) to about 0.009 inch (0.23 mm), and more preferably is within the range of about 0.0065 inch (0.165 mm) to about 0.0085 inch (0.22 mm).

Optionally, the radius of curvature of all four of the curved surfaces 20, 22, 24, 26 is approximately the same. However, other constructions are also possible. For example, the radius of curvature of the first and second curved surfaces 20, 22 may be larger than the radius of curvature of the third and fourth curved surfaces 24, 26.

FIG. 3a is a longitudinal cross-sectional view of an archwire 10a according to an alternative embodiment of the invention. The archwire 10a has a facial side 12a, an occlusal side 14a, a lingual side 16a and a gingival side 18a. The archwire 10a also has a curved surface 20a interconnecting the occlusal side 14a and the lingual side 16a, a curved surface 22a interconnecting the lingual side 16a and the gingival side 18a, a curved surface 24a interconnecting the occlusal side 14a and the facial side 12a, and a curved surface 26a interconnecting the facial side 12a and the gingival side 18a.

However, in this embodiment, the curved surfaces 20a, 22a adjacent the lingual side 16a have a greater radius of curvature than the curved surfaces 24a, 26a adjacent the facial side 12a. Preferably, the radius of curvature of the curved surfaces 20a, 22a is within the range of the radius of curvature described above with respect to the curved surfaces 20, 22 shown in FIG. 3. By contrast, the radius of curvature of the curved surfaces 24a, 26a is significantly smaller, such as 0.003 inch (0.08 mm).

FIG. 4 is a longitudinal cross-sectional view of a typical prior art orthodontic archwire 100 known in the past. The archwire 100 depicted in FIG. 4 has four flat sides and four curved surfaces interconnecting the flat sides. However, the radius of curvature of the curved surfaces of the archwire 100 in FIG. 4 is 0.003 in. (0.08 mm) for a wire size designated 0.019 in. by 0.025 in. (0.48 mm by 0.63 mm). By comparison of FIG. 4 to FIG. 3, it can be appreciated that the radius of curvature of the curved surfaces of the archwire 100 is significantly smaller than the radius of curvature of the curved surfaces of the archwire 10.

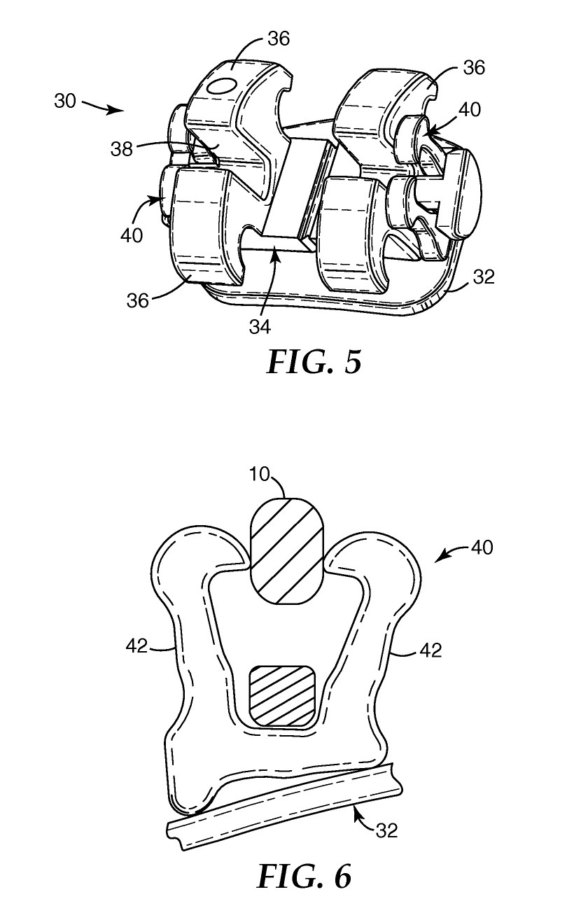

In FIGS. 1 and 2, each of the upper and lower orthodontic braces 56, 58 includes a number of orthodontic brackets 30 that are affixed to the patient's teeth. An enlarged illustration of an exemplary orthodontic bracket 30 is shown in FIG. 5, and is a “self-ligating” bracket that is sold under the brand name “SMARTCLIP” by 3M Unitek Corporation. However, other brackets are also possible.

The exemplary bracket 30 shown in FIG. 5 has a base 32 for directly bonding the bracket 30 to the enamel surface of a patient's tooth. The bracket 30 includes a body 34 that extends outwardly from the base 32, and the body 34 is connected to four spaced-apart tiewings 36.

An archwire slot 38 extends in a generally mesial-distal direction across the body 34 and between the tiewings 36 of the bracket 30. The bracket 30 as shown in FIG. 5 also has a latch comprising two releasable spring clips 40 for releasably retaining an archwire such as the archwire 10 in the archwire slot 38. Additional aspects and alternative constructions of the bracket 30 and latch are set out in U.S. Pat. Nos. 6,302,688 and 6,582,226, published U.S. patent application No. 2004/0086825 and applicant's pending U.S. Patent application entitled “Pre-torqued Orthodontic Appliance with Archwire Retaining Latch, Ser. No. 11/050,615 filed Feb. 2, 2005.

FIG. 6 shows for purposes of illustration the archwire 10 as it moves into the archwire slot 38 of the bracket 30 for engagement with the clips 40 of the latch. As shown, the curved surfaces 20, 22 of the archwire 10, when pressed against the outer curved surfaces of arms 42 of the clip 40, help to facilitate spreading movement of the arms 42 in directions away from each other in order to admit the archwire 10 into the archwire slot 38. The increased radius of curvature of the curved surfaces 20, 22 facilitates opening movement of the clip 40 so that undue pressure need not be exerted on the bracket 30. As a result, less pressure is placed on the patient's tooth during engagement of the archwire 10 with the latch of the bracket 30, which may help avoid patient discomfort.

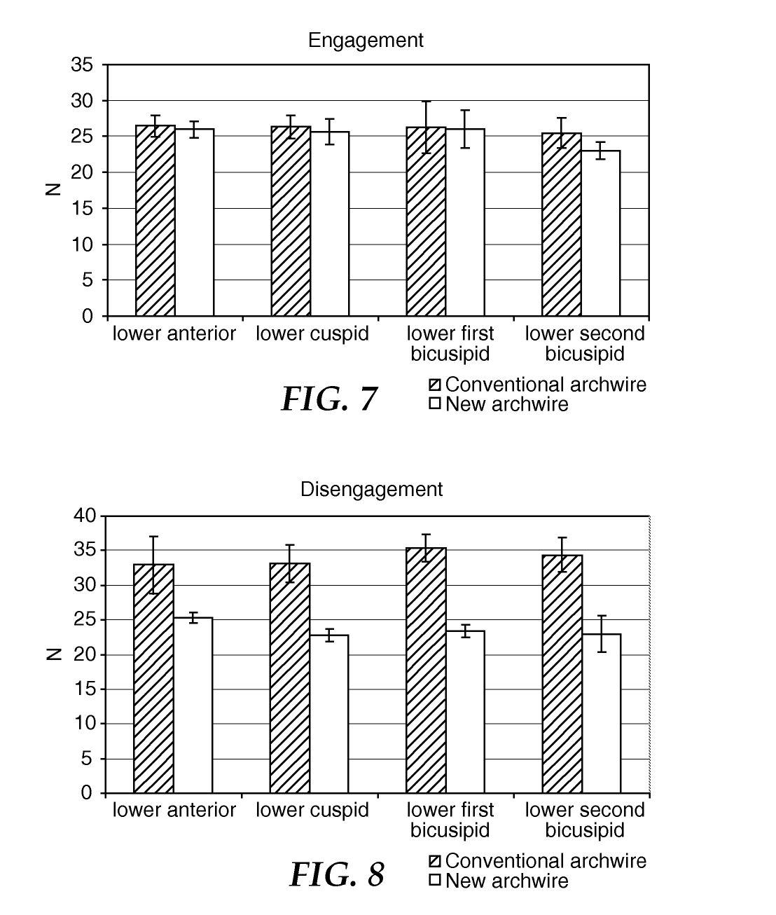

FIG. 7 is a graph depicting experimental results of the force needed to engage an archwire 10 of the present invention with the latch of the bracket 30, in comparison to the force need to engage a conventional archwire 100 with the same bracket. In FIG. 7, the archwire 10 or “new archwire” is the 21×25 inch stainless steel archwire set out in Table I, while the conventional archwire is a 19×25 inch stainless steel archwire with corner radii of 0.003 inch. The data of FIG. 7 shows that the force needed to engage the archwire 10 with the latch is substantially the same or slightly smaller than the force needed to engage the archwire 100 with the latch.

FIG. 8 is a graph depicting experimental results of the force needed to disengage an archwire 10 of the present invention with the latch of the bracket 10, in comparison to the force needed to engage a conventional archwire 100 with the same bracket. In FIG. 8, the “new archwire” and “conventional archwire” are the same archwires described above with respect to FIG. 7. FIG. 8 shows that the disengagement force for disengaging the archwire from the latch of the bracket 30 is significantly smaller for the archwire 10 in comparison to the disengagement force for the archwire 100. As a consequence, the patient may experience less discomfort when the archwire 10 is removed from the appliances.

In FIGS. 7 and 8, values for “N” are expressed in units of newtons. To determine the force to disengage the archwire and release from the clips 40 of the latch, a section of archwire is selected. Next, a sling is constructed and is connected to the archwire section at locations closely adjacent, but not in contact with the heads of the mesial and distal supports that support the clips 40. Optionally, the sling is welded or brazed to the archwire section. Next, the sling is pulled away from the appliance 30 while the appliance 30 is held in a stationary position, taking care to ensure that the longitudinal axis of the archwire section does not tip relative to the longitudinal axis of the archwire slot 38. The force to release the archwire section from the clips 40 of the latch may be determined by use of an Instron testing apparatus connected to the sling, using a crosshead speed of 0.5 in/min (1.3 cm/min). Alternatively, a shaker apparatus (such as Model 300 from APS Dynamics of Carlsbad, Calif.) may be used along with a force transducer (such as model 208C01 from PCB of Buffalo, N.Y.) to measure the force. To determine the force to engage the latch, a similar test is carried out, using a yoke to push the section of archwire against the latch.

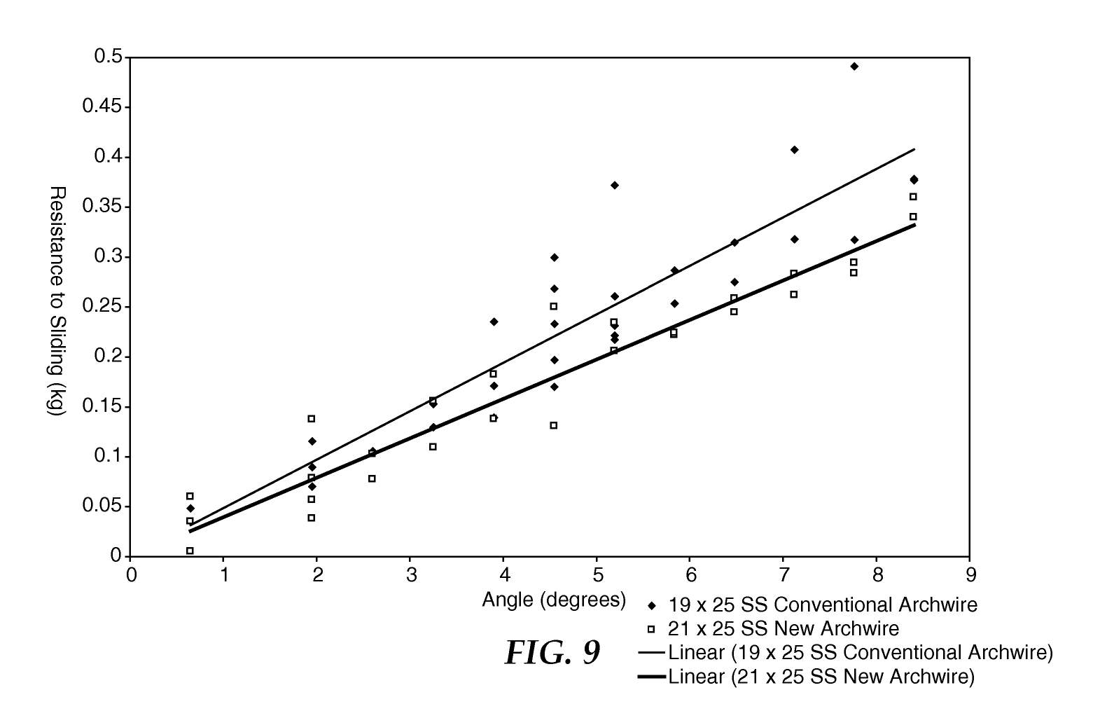

FIG. 9 is a graph depicting resistance to sliding movement of orthodontic archwires in the archwire slots of self-ligating brackets. In this instance, the brackets were upper left bicuspid “MBT” “SMARTCLIP” brand brackets with hook, catalog no. 004-317, from 3M Unitek Corporation.

To obtain the data from the graph depicted in FIG. 9, three of the brackets were mounted in a row on a fixture such that the archwire slots were originally aligned along a common mesial-distal reference axis. However, the fixture was constructed to enable the middle bracket to be moved in directions along an occlusal-gingival reference axis to various positions relative to the other two brackets (which remained stationary). An orthodontic archwire was then placed in the slots of the three brackets, and one end of the archwire was coupled to an “MTS” brand testing machine.

The MTS machine was activated to pull the archwire in a direction along its longitudinal axis at a rate of 10 mm/min. As the archwire is pulled along the slots of the three brackets, the MTS machine determined the amount of force needed to maintain the rate at a constant speed.

The fixture was then manipulated to vary the position of the middle bracket relative to the other two brackets. In one experiment, the archwire slot of the middle bracket was aligned with the archwire slot of the remaining two brackets such that the archwire slots of all three brackets extended along a common mesial-distal reference axis. The MTS machine then pulled the archwire along the slots of the brackets and recorded the amount of force. In other experiments, the middle bracket was moved in an occlusal direction to various positions such that the archwire extended at a certain angle relative to the longitudinal axis of the archwire slots. This angle varied from about 0.6 degrees to about 8.6 degrees, depending on the distance that the middle bracket was moved in an occlusal direction. At each position, the MTS machine pulled archwire along the slots of the brackets and recorded the amount of force.

In FIG. 9, the correlation coefficient (R²) of the data for the best fit straight line was 0.9275 for the data relating to the archwire 10 of the present invention and 0.816 for the data relating to the archwire 100. The average binding coefficient of the archwires was then calculated from the slope of the lines shown in FIG. 9. The binding coefficient was 39.5 grams/degree for the archwire 10 of the present invention and 48.5 grams/degree for the conventional archwire 100.

The graphs of the data as set out in FIG. 9 and the calculated binding coefficients show that the orthodontic archwires 10 according to the present invention exhibit less resistance to sliding movement in comparison to orthodontic archwires 100 known in the past, even though the occlusal-gingival dimension (0.025 inch, or 0.63 mm) of the archwire 10 is significantly greater than the occlusal-gingival dimension (0.019 inch, or 0.48 mm) of the archwire 100. Advantageously, the larger occlusal-gingival dimension of the archwire 10 compared to the archwire 100 enables the orthodontist to maintain good torque control of the associated bracket even though the corners of the archwire 10 have a significantly larger radius of curvature than the radius of curvature of the corners of the archwire 100. The archwire 10 also provides better translational control over the associated brackets due to reduced sliding friction as the brackets slide laterally along the archwire 10 as may occur, for example, during intra-arch consolidation. As a result, precise control over movement of the patient's tooth to a desired, final location is facilitated.

The archwires 10, 10a have an overall, generally “U”-shaped configuration when viewed in directions along an occlusal-gingival reference axis, and extend in horizontal plane when the archwires 10, 10a are relaxed. However, other configurations are possible. For example, the archwires 10, 10a could be provided with a curve of Spee.

Suitable materials for the archwires 10, 10a include stainless steel such as AISI 300 series including type 304V, precipitation-hardening type stainless steels such as 17-7 pH, cobalt chromium alloys such as Elgiloy brand alloy, shape-memory alloys such as nickel-titanium and ternary-substitution nickel-titanium alloys including copper nickel-titanium alloys, and titanium alloys such as beta-titanium. Non-metallic materials may also be used.

All of the patents and patent applications mentioned above are expressly incorporated by reference herein. Additionally, the invention should not be deemed limited to the presently preferred embodiments that are described above in detail, but instead only by a fair scope of the claims that follow along with their equivalents.

1. An orthodontic archwire having a central longitudinal axis and four generally flat sides including a lingual side that together present a generally rectangular configuration in a reference plane perpendicular to the longitudinal axis, wherein the archwire also has four curved surfaces interconnecting the four sides, and wherein each curved surface adjacent the lingual side has a radius of curvature when considered in the reference plane that is in the range of about 30% to about 45% of the overall distance between two of the sides in directions along an occlusal-gingival reference axis.

2. An orthodontic archwire according to claim 1 wherein each curved surface adjacent the lingual side has a radius of curvature when considered in the reference plane that is in the range of about 35% to about 42% of the overall distance between two of the sides in directions along the reference axis.

3. An orthodontic archwire according to claim 1 wherein all four of the curved surfaces have a radius of curvature when considered in the reference plane that is in the range of about 30% to about 45% of the overall distance between two of the sides in directions along the reference axis.

4. An orthodontic archwire according to claim 1 wherein all four of the curved surfaces have a radius of curvature when considered in the reference plane that is in the range of about 35% to about 42% of the overall distance between two of the sides in directions along the reference axis.

5. An orthodontic archwire according to claim 1 wherein the radius of curvature is in the range of about 0.006 in. to about 0.009 in.

6. An orthodontic archwire according to claim 1 wherein the radius of curvature is in the range of about 0.0065 in. to about 0.0085 in.

7. An orthodontic archwire according to claim 1 wherein the archwire is made of a material that comprises an alloy of stainless steel.

8. An orthodontic archwire according to claim 1 wherein the archwire is made of a material comprising an alloy of nickel and titanium or an alloy of beta-titanium.

9. An orthodontic archwire according to claim 1 wherein the archwire is made of a material comprising a shape memory alloy.

10. An orthodontic archwire having a central longitudinal axis and four generally flat sides that present a generally rectangular configuration in a reference plane perpendicular to the longitudinal axis, wherein the archwire also has four curved surfaces interconnecting the four sides, wherein the radius of curvature of each of the curved surfaces in the reference plane is in the range of about 0.006 inch to about 0.009 inch.

11. An orthodontic archwire according to claim 10 wherein the radius of curvature is in the range of about 0.0065 inch to about 0.0085 inch.

12. An orthodontic archwire according to claim 10 wherein the archwire is made of a material that comprises an alloy of stainless steel.

13. An orthodontic archwire according to claim 10 wherein the archwire is made of a material comprising an alloy of nickel and titanium or an alloy of beta-titanium.

14. An orthodontic archwire according to claim 10 wherein the archwire is made of a material comprising a shape memory alloy.

15. An orthodontic brace comprising at least one bracket having an elongated archwire slot and an elongated archwire received in the archwire slot, the archwire including four generally flat sides including a lingual side that together present a generally rectangular configuration in a reference plane perpendicular to the longitudinal axis of the archwire, and wherein the archwire has four curved surfaces interconnecting the four sides, wherein the archwire slot and the archwire each have a certain average overall dimension in directions along an occlusal-gingival reference axis, wherein the average overall dimension of the archwire along the reference axis is in the range of about 76% to about 94% of the average overall dimension of the archwire slot along the reference axis, and wherein each of the curved surfaces adjacent the lingual side has a radius of curvature in the reference plane that is in the range of about 30% to about 45% of the overall dimension of the archwire along the reference axis.

16. An orthodontic brace according to claim 15 wherein each of the curved surfaces adjacent the lingual side has a radius of curvature in the reference plane that is in the range of about 35% to about 42% of the overall average dimension of the archwire along the reference axis.

17. An orthodontic archwire according to claim 15 wherein all four of the curved surfaces have a radius of curvature when considered in the reference plane that is in the range of about 30% to about 45% of the overall distance between two of the sides in directions along the reference axis.

18. An orthodontic archwire according to claim 15 wherein all four of the curved surfaces have a radius of curvature when considered in the reference plane that is in the range of about 35% to about 42% of the overall distance between two of the sides in directions along the reference axis.

19. An orthodontic brace according to claim 15 wherein the radius of curvature is in the range of about 0.006 inch to about 0.009 inch.

20. An orthodontic brace according to claim 15 wherein the radius of curvature is in the range of about 0.0065 inch to about 0.0085 inch.

21. An orthodontic brace according to claim 15 wherein the archwire is made of a material that comprises an alloy of stainless steel.

22. An orthodontic brace according to claim 15 wherein the archwire is made of a material comprising an alloy of nickel and titanium or an alloy of beta-titanium.

23. An orthodontic brace according to claim 15 wherein the archwire is made of a material comprising a shape memory alloy.

24. An orthodontic brace according to claim 15 wherein the bracket is a self-ligating bracket.

25. An orthodontic brace according to claim 24 wherein the bracket includes a latch having at least one releasable clip.
